(19) United States
(12) Patent Application Publication
(10) Pub. No.: US 2006/0042736 A1
(43) Pub. Date: Mar. 2, 2006

(54) Small tire used in electromotive scooters and small size motor vehicles

(76) Inventor: Ying-Ming Yang, Changhua (TW)

Correspondence Address: Ying-Ming Yang, 235 Chung-Ho, Box 8-24, Taipei, TW

(21) Appl. No.: 10/924,129

(22) Filed: Aug. 24, 2004

(51) Int. Cl. B60C 19/12

(52) U.S. Cl. 152/192; 152/508

(57) ABSTRACT

A small tire used in electromotive scooters and small size motor vehicles comprises a tire having an annular groove; an annular bottom of the annular groove being installed with a protecting layer with a predetermined thickness for protection the tire from being pierced; the tire being formed with a pair of tire lips at two sides of an opening of the tire; a tire frame being combined with the pair of tire lips; the ring having two round walls at two outer opposite sides of the tire ring; an annular trench being formed between the two round walls; an inner side of each round wall protruded with an annular protruded wall; a receiving space being formed between the protruded wall and the round wall for receiving a respective tire lip; and the tire lips being tightly adhered to the annular protruded walls and the round walls.

### FIELD OF THE INVENTION

The present invention relates to tires, and particularly to a small tire used in electromotive scooters and small size motor vehicles.

### BACKGROUND OF THE INVENTION

Currently, the electromotive scooters and small size motor vehicles are used for children, exercisers and disablers. To have a preferred shock-proof structure, shockproof systems and tires must be well designed.

In the prior art, the rubber tires are used in the electromotive scooters and small size motor vehicles. The softness of the rubber and superior support from the rubber tires make the shock be absorbed effectively.

However the prior art tires for electromotive scooters and small size motor vehicles are not preferred in the pierce-proof. To improve the pierce proof ability, a layer of PU layer is filled into the tire so that the tire has a solid structure and thus it is unnecessary to inflate the tire.

The PU layer will increase the cost of the tire, and moreover, the PU layer cannot provide a well support to the tire. Thus the passengers will feel uneasy in the driving period. Thereby the PU layer will increase the weight of the tire so as to affect the driving of the small tire used in electromotive scooters and small size motor vehicles.

### SUMMARY OF THE INVENTION

Accordingly, the primary object of the present invention is to provide a small tire used in electromotive scooters and small size motor vehicles wherein the annular protruded wall protruded from one round wall of the tire frame for adhering the tire lips of the tire causes that the air inflation rubber tire has an optimum air-tight effect. Thereby the protecting layer for pierce-proof in a bottom of the annular groove of the tire which is made of pierce-proof rubber. The pierce-proof rubber has the effect of providing an extension to the tire as the tire is in driving state.

Furthermore, as an object pierces into the tire, the pierce-proof rubber will tightly clamp the object so as to retain the air-tight effect of the tire. When the piercing object is taken out, the pierce-proof rubber will fill the hole automatically. Thereby the tire has a preferred air-tight effect.

To achieve above objects, the present invention provides a small tire used in electromotive scooters and small size motor vehicles which comprises a tire having an annular groove; an annular bottom of the annular groove being installed with a protecting layer with a predetermined thickness for protection the tire from being pierced; the tire being formed with a pair of tire lips at two sides of an opening of the tire; a tire frame being combined with the pair of tire lips; the tire having two round walls at two outer opposite sides of the tire ring; an annular trench being formed between the two round walls; an inner side of each round wall protruded with an annular protruded wall; a receiving space being formed between the protruded wall and the round wall for receiving a respective tire lip; and the tire lips being tightly adhered to the annular protruded walls and the round walls.

The various objects and advantages of the present invention will be more readily understood from the following detailed description when read in conjunction with the appended drawing.

### BRIEF DESCRIPTION OF THE DRAWINGS

FIG. 1 is a schematic view of the tire structure of the present invention.

FIG. 2 is a schematic view of the tire frame of the present invention.

FIG. 3 is a schematic perspective view of the tire of the present invention.

FIG. 4 is a partial cross sectional view of the tire of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

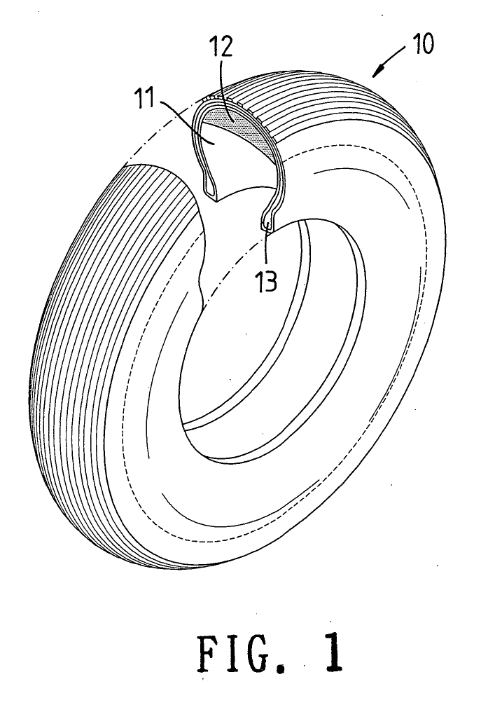

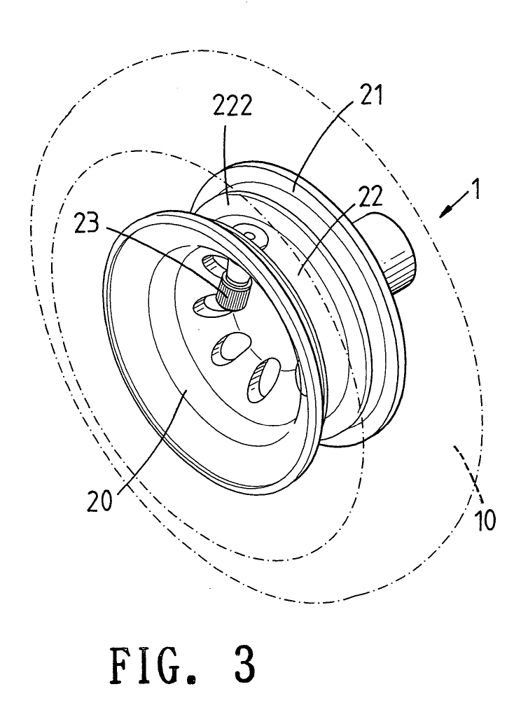

With reference to FIGS. 1 and 3, the small tire used in electromotive scooters and small size motor vehicles of the present invention is illustrated. The small tire used in electromotive scooters and small size motor vehicles has the following elements.

A tire 10 is made of soft rubber. The tire 10 has an annular groove 11. An annular bottom of the annular groove 11 is placed with a protecting layer 12 with a predetermined thickness for protection of the tire from being pierced. The material of the protecting layer 12 is pierce-proof rubber. When the tire 12 is pierced so as to form a hole, the rubber will compensate the hole. Thereby, the tire is pierce-proofed. The tire 10 is formed with a pair of tire lips 13 at two sides of an opening of the tire 10.

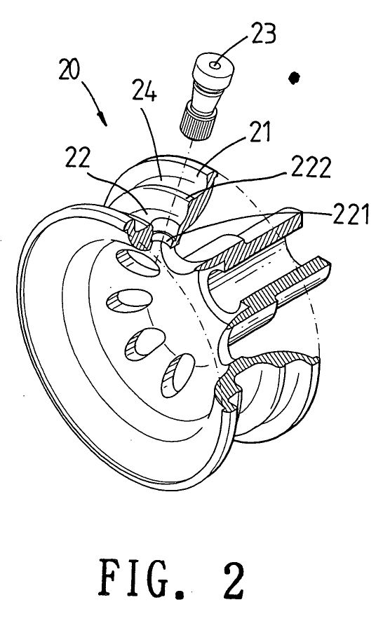

A tire frame 20 (see FIG. 2) is combined with the pair of tire lips 13 so that an interior of the tire is an airtight structure. The ring 20 has two round walls 21 at two outer opposite sides of the tire ring 20. An annular trench 22 is formed between the two round walls 21. An air valve hole 221 is formed in the annular trench 22. The air valve hole 221 obliquely penetrates through a bottom of the annular trench 22 toward one of the two round walls 21. An air valve 23 is installed in the air valve hole 221 and one input end of the air valve 23 exposes on an outer side of the round wall 21. Thereby air is inflated into the tire 10 from the outer side of the round wall 21.

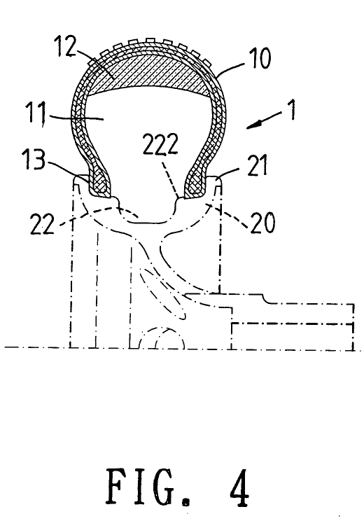

An inner side of each round wall 21 is protruded with an annular protruded wall 222. A receiving space 24 is formed between the protruded wall 222 and the round wall 21 for receiving a respective tire lip 13. The tire lips 13 are tightly adhered to the annular protruded walls 222 and the round walls 21, see FIG. 4. Thereby the annular trench 22 of the tire frame 20 is tightly combined to the annular groove 11 of the tire 10, see FIG. 3.

In the small tire of the present invention, the annular protruded wall 222 protruded from one round wall 21 of the tire frame 20 for adhering the tire lips 13 of the tire 10 causes that the air inflation rubber tire 10 has an optimum air-tight effect. Thereby the protecting layer 12 for pierce-proof in a bottom of the annular groove 11 of the tire 10 which is made of pierce-proof rubber. The pierce-proof rubber has the effect of providing an extension to the tire 10 as the tire 10 is in driving state.

Furthermore, as an object pierces into the tire 10, the pierce-proof rubber will tightly clamp the object so as to retain the airtight effect of the tire 10. When the piercing object is taken out, the pierce-proof rubber will fill the hole automatically. Thereby the tire 10 has a preferred airtight effect.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A small tire used in electromotive scooters and small size motor vehicles comprising:
a tire having an annular groove; an annular bottom of the annular groove being installed with a protecting layer with a predetermined thickness for protection the tire from being pierced; the tire being formed with a pair of tire lips at two sides of an opening of the tire;
a tire frame being combined with the pair of tire lips so that an interior of the tire being an air-tight structure; the tire frame having two round walls at two outer opposite sides of the tire ring; an annular trench being formed between the two round walls;
an inner side of each round wall protruded with an annular protruded wall; a receiving space being formed between the protruded wall and the round wall for receiving a respective tire lip; the tire lips being tightly adhered to the annular protruded walls and the round walls.

2. The small tire used in electromotive scooters and small size motor vehicles as claimed in claim 1, wherein the material of the protecting layer is pierce-proof rubber.

3. The small tire used in electromotive scooters and small size motor vehicles as claimed in claim 1, wherein an air valve hole is formed in the annular trench; the air valve hole obliquely penetrates through a bottom of the annular trench toward one of the two round walls; and an air valve is installed in the air valve hole and one input end of the air valve exposes on an outer side of the round wall.
